(19) United States
(12) Patent Application Publication
(10) Pub. No.: US 2010/0165396 A1
(43) Pub. Date: Jul. 1, 2010

(54) INFORMATION COMMUNICATION SYSTEM, USER TERMINAL AND INFORMATION COMMUNICATION METHOD

(75) Inventor: Shuhei YAMAGUCHI, Tokyo (JP)

Correspondence Address: CANTOR COLBURN, LLP, 20 Church Street, 22nd Floor, Hartford, CT, 06103, US

(73) Assignee: DWANGO CO., LTD., Tokyo (JP)

(21) Appl. No.: 12/647,089

(22) Filed: Dec. 24, 2009

(30) Foreign Application Priority Data
Dec. 26, 2008 (JP) 2008-332593

(51) Int. Cl. G06F 3/12

(52) U.S. Cl. 358/1.15

(57) ABSTRACT

An information communication system comprising a plurality of user terminals which output contents delivered via a network and accept input of comments relating to the contents, and an information communication server which receives the comments input by the user terminals and delivers the comments to a plurality of user terminals, the information communication server comprising: a classification control unit which generates a classification according to user properties of a user terminal, and assigns the classification to the user terminal; the user terminal comprising: a classification selection input unit which acquires one of a first selection and a second selection, all comments transmitted by a plurality of the user terminal are outputted in the first selection, and the comment transmitted by the user terminal assigned same classification of the user terminal is only outputted in the second selection; a comment extracting unit which extracts all the comments delivered by the information communication server as an output comment when the first selection is inputted in the classification selection input unit, and extracts the comment transmitted by the user terminal assigned the classification which is the same as the user terminal in the comments delivered by the information communication server when the second selection is inputted in the classification selection input unit; and an output unit which outputs the output comment extracted by the comment extracting unit with the contents.

### BACKGROUND OF THE INVENTION

1. Field of the Invention

The present invention relates to an information communication system, a user terminal and an information communication method which uses a user terminal which outputs contents delivered via a network and acquires a comment according to the contents, and an information communication server which receives the comment inputted in a plurality of user terminals.

Priority is claimed on Japanese Patent Application No. 2008-332593, filed Dec. 26, 2008, the contents of which are incorporated herein by reference.

2. Description of Related Art

In a conventional information communication system, an information communication server which is connected to a plurality of user terminals delivers a comment inputted to a user terminal according to video information delivered to the user terminal via a network. Such information communication system is used to allow a plurality of users to watch the common video concurrently and to give comments thereon to each other in real time, thereby providing realistic communication.

As such technology for control of transmitting and receiving the comment between a plurality of user terminals, for example, Patent Document 1 discloses an information communication system which manages the comments transmitted by the user terminal by separating a plurality of information communication servers. According to such an information communication system, if a lot of user terminals join the system, it is possible to decrease the number of the user terminals which are managed by one information communication server, and it is possible to disperse the heavy process load into light process loads to the information communication servers.

Patent Document 1: Japanese Unexamined Patent Publication, First Publication No. H10-334021

### SUMMARY OF THE INVENTION

However, in such an information communication system, for example, if one thousand user terminals are connected and comments are inputted for the same video, a problem occurs. If all the comments transmitted by the user terminals are simultaneously delivered to one user terminal, the user can realize the trend and atmosphere to the same video of all users, however it is difficult for the user to read all of the comments and understand them. In this case, some comments which relate to specific topics are buried in a lot of comments. Therefore, smooth communication between specific users is hard to achieve.

In addition, if approximately one thousand user terminals are separated into 20 groups, and the comments are only delivered to user terminals which are in the same group, a problem occurs. In this case, the communication in the group may be established, however, the communication between limited users is only established. Then, communication with a large number of anonymous users in another group is not established, and the user can not realize that a lot of users are watching a common video.

The present invention was created in light of the aforementioned circumstances, and an object thereof is to provide an information communication system, a user terminal, and an information communication method allows all users to be watching a common video concurrently, and to do communication among specific users.

(1) According to one aspect of the present invention, there is provided an information communication system comprising a plurality of user terminals which output contents delivered via a network and accept input of comments relating to the contents, and an information communication server which receives the comments input by the user terminals and delivers the comments to a plurality of user terminals, the information communication server comprising: a classification control unit which generates a classification according to user properties of a user terminal, and assigns the classification to the user terminal; the user terminal comprising: a classification selection input unit which acquires one of a first selection and a second selection, all comments transmitted by a plurality of the user terminal are outputted in the first selection, and the comment transmitted by the user terminal assigned same classification of the user terminal is only outputted in the second selection; a comment extracting unit which extracts all the comments delivered by the information communication server as an output comment when the first selection is inputted in the classification selection input unit, and extracts the comment transmitted by the user terminal assigned the classification which is the same as the user terminal in the comments delivered by the information communication server when the second selection is inputted in the classification selection input unit; and an output unit which outputs the output comment extracted by the comment extracting unit with the contents.
(2) Moreover, in the above described information communication system, wherein the information of the contents to be outputted varies over time; and the classification control unit of the information communication server generates a new classification according to the change of the contents, and assigns the new classification to the user terminal among a plurality of user terminals based on the new classification.
(3) Moreover, in the above described information communication system, wherein the user terminal further comprises a classification generation requesting unit which transmits the generation request according to the inputted user property to the information communication server, the classification control unit of the information communication sever generates a new classification according to the classification generation request transmitted by the classification generation requesting unit of the user terminal, and assigns the new classification to the user terminal among a plurality of user terminals based on the new classification.
(4) Moreover, in the above described information communication system, wherein the comment extracting unit of the user terminal extracts the comment transmitted by the user terminal assigned the new classification among the comments transmitted to the information communication server as the second selection is inputted when the new classification is assigned by the classification control unit.
(5) Moreover, in the above described information communication system, wherein the classification control unit of the information communication server deletes the generated new classification based on the predetermined condition.
(6) According to another aspect of the present invention, there is provided an information communication method using a plurality of user terminals which output contents delivered via a network and accept input of comments relating to the contents, and an information communication server which receives the comments input by the user terminals and delivers the comments to a plurality of user terminals, the information communication method comprising: performing, by the information communication server, a classification controlling process which generates a classification according to user properties of a user terminal, and assigns the classification to the user terminal; performing, by the user terminal, a classification selection inputting process which acquires one of a first selection and a second selection, all comments transmitted by a plurality of the user terminal are outputted in the first selection, and the comment transmitted by the user terminal assigned same classification of the user terminal is only outputted in the second selection; performing, by the user terminal, a comment extracting process which extracts all the comments delivered by the information communication server as an output comment when the first selection is inputted in the classification selection inputting process, and extracts the comment transmitted by the user terminal assigned the classification which is same as the user terminal in the comments delivered by the information communication server when the second selection is inputted in the classification selection inputting process; and performing, by the user terminal, an outputting process which outputs the output comment extracted by the comment extracting step with the contents.

### EFFECT OF THE INVENTION

As described above, according to the present invention, the information communication server generates a classification according to user properties of a user terminal, and assigns the classification to the user terminal. Then, the user terminal acquires one of a first selection and a second selection, all comments transmitted by a plurality of the user terminal are outputted in the first selection, and the comment transmitted by the user terminal assigned same classification of the user terminal is only outputted in the second selection, extracts all the comments delivered by the information communication server as an output comment when the first selection is inputted in the classification selection input unit, and extracts the comment transmitted by the user terminal assigned the classification which is same as the user terminal in the comments delivered by the information communication server when the second selection is inputted in the classification selection input unit; and outputs the output comment extracted by the comment extracting unit with the contents. Therefore the user terminal is able to switch to output all the comments which are delivered and outputting only the comment transmitted by the user terminals which are the same classification assigned based on the user property. Therefore, a user who watches the contents with the comments outputted from the user terminals allows all users to watch a common video concurrently by watching the comments from all users and the contents when the first selection is inputted. In addition, the user is able to multiple communicate between the specific users by reading comments from the user terminals which have the same user properties with the contents when the second selection is inputted.

### BRIEF DESCRIPTION OF THE DRAWINGS

FIG. 1 is a block diagram showing an information communication system according to the embodiment of the present invention.

FIG. 2 is a table showing an example of user data according to the embodiment of the present invention.

FIG. 3 is a diagram showing an example of a display on a screen of the user terminal according to the embodiment of the present invention.

FIG. 4 is a diagram showing an example of a display on a screen of the user terminal according to the embodiment of the present invention.

FIG. 5 is a diagram showing an example of a display on a screen of the user terminal according to the embodiment of the present invention.

FIG. 6 is a sequence diagram showing an example of the operation of the information communication system according to the embodiment of the present invention.

FIG. 7 is a sequence diagram showing an example of the operation of the information communication system according to the embodiment of the present invention.

### REFERENCE SYMBOLS

1 information communication system
100 video delivery server
101 video storage unit
102 video delivery unit
200 comment server
201 comment receiving unit
202 comment analyzing unit
203 comment storage unit
204 use information storage unit
205 thread control unit
206 comment delivery unit
300 use terminal
301 input unit
302 thread generation requiring unit
303 comment transmission unit
304 transmission and reception unit
305 comment extracting unit
306 output unit

### DETAILED DESCRIPTION OF THE INVENTION

An embodiment of the present invention is described below with reference to the figures.

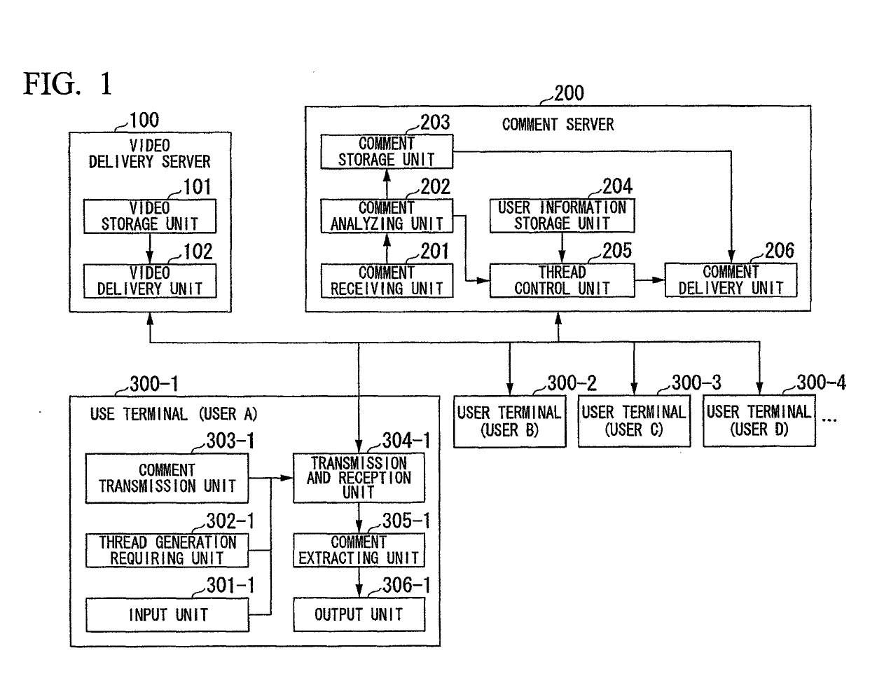

FIG. 1 is a block diagram showing an information communication system 1 according to the embodiment. The information communication system 1 includes an video delivery server 100, a comment server 200, and a plurality of user terminals 300 (a user terminal 300-1, a user terminal 300-2, a user terminal 300-3, a user terminal 300-4, . . . ). These devices are connected via a network. The configurations of a plurality of user terminals 300 are the same. Therefore, the user terminals 300 have the same configuration, provided the user terminal having a different configuration is allocated with a different reference number.

The video delivery server 100 is a computer device which delivers the video information to the user terminal 300, and includes a video storage unit, and a video delivery unit. The video storage unit stores video information which is delivered to the user terminal 300. The video delivery unit establishes the connection to the user terminal 300 which is completed with the log in to the comment server 200. The video delivery unit delivers streaming the video information stored in the video storage unit 101 to the user terminal 300. The video information which is delivered by the video delivery unit 102 may be the predetermined video information or the video information which is generated in real time. For example, the video information may be preliminary shot cooking program, or video information may be the baseball game information which is inputted in real time.

The comment server 200 is a computer device which delivers comments inputted to the user terminal 300 according to the video information delivered from the video delivery server to the user terminal 300. The comment server 200 includes a comment receiving unit 201, a comment analyzing unit 202, a comment storage unit 203, a user information storage unit 204, a thread control unit 205, and a comment delivery unit 206.

The comment receiving unit 201 receives a comment, via the network, inputted to the user terminals 300 according to the video information delivered to the user terminal 300 by the video delivery server 100. The comment received by the comment receiving unit 201 is a normal comment or a command comment. A normal comment is a character string which is freely inputted by the user, is transmitted to other user terminal 300 and is displayed. In addition, the command comment is a predetermined character string for requesting the specific process to the comment server 200. For example, the command comment can be a command for changing the operation of the comment server 20, an execution command for the predetermined effective expression, or a command character string which is for instructing a character color, size or display location of the normal comment. For example, star-shaped letters are temporarily displayed entirely on a video screen effectively and realistically, and AA (ASCII Art) are displayed.

The comment analyzing unit 202 analyzes the comment received by the comment receiving unit 201. The comment analyzing unit 202 performs the predetermined process according to the command comment when the comment received by the comment receiving unit 201 is the command comment. For example, if the command comment expresses the effective expression, the comment storage unit 203 stores the character string according to the received command comment. In addition, if the received comment is the normal comment, the comment analyzing unit 202 stores the received comment into the comment storage unit 203.

The comment storage unit 203 stores the comment information received by the comment receiving unit 201 from the user terminal 300. For example, the comment information stored in the comment storage unit 203 includes a number which indicates the sequence of the received comment by the comment receiving unit 201, the user ID of the user terminal 300 which transmitted the comment, the play time of the video information which the comment receiving unit 201 receives the comment, and the content of the comments.

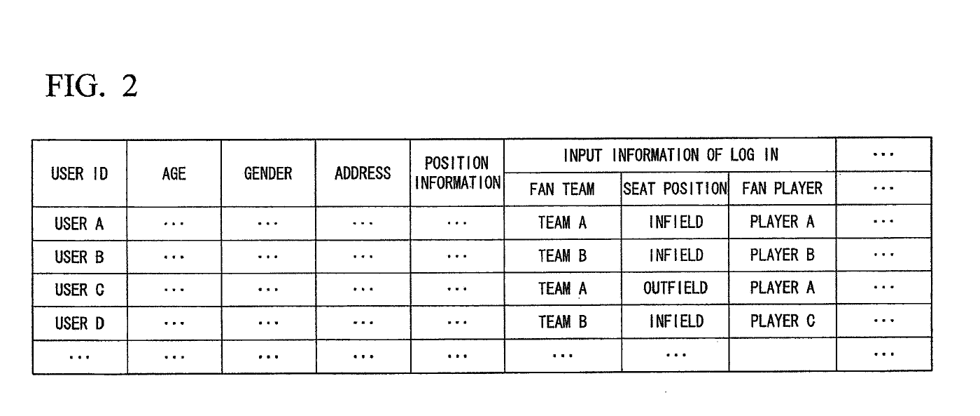

The user information storage unit 204 stores the property information of a user who is able to use the information communication service which is provided by the information communication system. FIG. 2 is a table showing an example of user data stored in the user data user information storage unit 204. The user data includes a user ID for identifying the user data, age, gender, address of user, the location information, the input information to log in and the like. The user address is, for example, the prefecture where the user lives. The user ID, the age, the gender and address of the user are stored in advance when the user account is generated.

The position information which is included in the user information is determined by the comment server 200 when the user logs in, and indicates the position relation of the user terminals which is determined based on the network connection of the user terminal 300. For example, if the comment server 200 includes a plurality of nodes, the position information is determined for every nodes which are connected to the user terminal 300.

The input information of the log in which is included in the user information is inputted from the user terminal 300 when the user terminal 300 logs in and is transmitted. For example, the comment server 200 acquires the input information which relates to the video information which is delivered when the log in request is received from the user terminal 300. For example, if the video information is baseball game information, the team information of which the user is a fun, the user's seat position at a virtual baseball stadium, or the player information of who the user is a fan is acquired. The comment server 200 generates the sub-thread of the comment according to the user property. Therefore, separately from the virtual communication space among all users, it is possible to generate the small communication space of the users who have the same properties.

In FIG. 1, the thread control unit 205 generates the classification according to the user property of the connected user terminal 300, the assignment of the user terminals is performed. Classifications generated by the thread control unit will be called to as threads. In the thread which is generated by the thread control unit 205, there are a main thread to which all user terminals belong and a sub-thread to which the users are assigned based on the user properties. The user terminal 300 always belongs to main thread without concerning the progress of the contents. However, relating to the sub-thread, it is possible to change and move a selection between the sub-threads which the user terminal is able to belong or between sub-thread and the main thread based on the request inputted by the user or the progress of the contents. For example, the thread control unit 205 classifies the user terminals 300 according to the user properties based on age or chronological orders, the gender, or the address or living area. Therefore the thread control unit 205 can generate sub-threads which have each property. The sub-thread which is assigned the user terminal 300 may set the limit of the comment number or the user number. The thread control unit 205 may assign user terminals to sub-threads such that the user number which belongs to each sub-thread is equal. However, may assign user terminals to sub-threads such that the user number is not equal. The sub-thread may be generated for every the position information of the network, the seat position, fan player, respectively. In this embodiment, it is possible to classify the user terminals which have the same property to the same thread by classifying the user terminals 300 for every sub-thread which is generated by the thread control unit 205.

In addition, the thread control unit 205 may generate a sub-thread which has a specific property according to the command comment which indicates the thread generation request which the comment receiving unit 201 receives from the user terminal 300. For example, when the video information of the baseball game is delivered to the user terminal and if the specific player stands in the batter's box, the command comment for generating the thread relating to the player may be received from the user terminal 300, and the sub-thread may be generated. In this case, it may be determined that each user information stored in the user information storage unit 204 corresponding to the user terminal 300 during log in corresponds to properties generated according to the generated sub-thread, the information which indicates the sub-thread is generated may be transmitted and notified to the corresponding user terminal 300. For example, if the sub-thread relating to the specific player standing in the batter's box is generated, then a notice of thread generation is given to the user terminals 300 which are inputted, in advance when the user log in, with the sub-thread identifying that the user is a fan of the player. In this case, when the thread control unit 205 receives the command comment which indicates the thread cancel request from the user terminal 300 which performed the request of the thread generation, the thread control unit 205 may cancel the generated sub-thread. In addition, if the specific player stands in the batter's box according to the change of the video information, the thread control unit 205 may automatically generate the sub-thread which has the property of the player without depending on the thread generation request from a user. In this case, if the batting order of the player is finished, the generated sub-thread may be canceled.

The comment delivery unit 206 only reads out the comments stored in the comment storage unit 203, and delivers them to a plurality of the user terminals 300.

The user terminal 300 is a computer device which is used by the user who watches the video. In this embodiment, the user terminal 300 is a PC (Personal Computer), however the user terminal may be a computer terminal like the PDA (Personal Digital Assistant) or the mobile phone terminal. In the embodiment, the user terminal 300-1 transmits and receives information with the server device (for example, the video delivery server 100, or the comment server 200) using an internet blower function which is installed in advance and operated. However the user terminal 300-1 may communicate with the server device using dedicated client software. The user terminal 300 includes an input unit 301, a thread generation requiring unit 302, a comment transmission unit 303, a transmission and reception unit 304, a comment extracting unit 305, and an output unit 306.

The input unit 301 is an input device (for example, a keyboard or a mouse) which acquires the operation information from the user. For example, the input unit 301 acquires the comment to the video which is delivered from the video delivery server 100 and is outputted to the output unit 306, and the information for selecting the thread which is displayed among a plurality of threads outputted to the output unit 306.

The thread generation requiring unit 302 transmits a new thread generation request to the comment server 200 based on the operation information from the user which is inputted from the input unit 301. For example, if the video information of a cooking program is delivered, the command comment which indicates the thread generation request relating to the topic of the specific material which is introduced in the program is transmitted to the comment server 200.

If the comment is inputted to the input unit 301 by the user according to the video which is delivered and displayed, the comment transmission unit 303 transmits the inputted comment to the comment server 200 via the transmission and reception unit 304.

The transmission and reception unit 304 communicates information with the video delivery server 100 and the comment server 200, and receives video information which is delivered the video delivery server 100 using the streaming delivery and comments which are transmitted from the comment server 200.

The comment extracting unit 305 extracts the comment corresponding to the thread selected by the user among the comments which are transmitted from the user terminal 300 to the comment server 200 and are delivered from the comment server 200, and outputs it to the output unit 306. If the input unit 301 acquires the selection of the main thread, the comment extracting unit 305 extracts all the comments which are delivered from the comment server 200. On the other hand, if the input unit 301 acquires the selection of the sub-thread, the comment extracting unit 305 extracts the comment as the output comment which is assigned the same classification of the self user terminal and is transmitted from the user terminal 300.

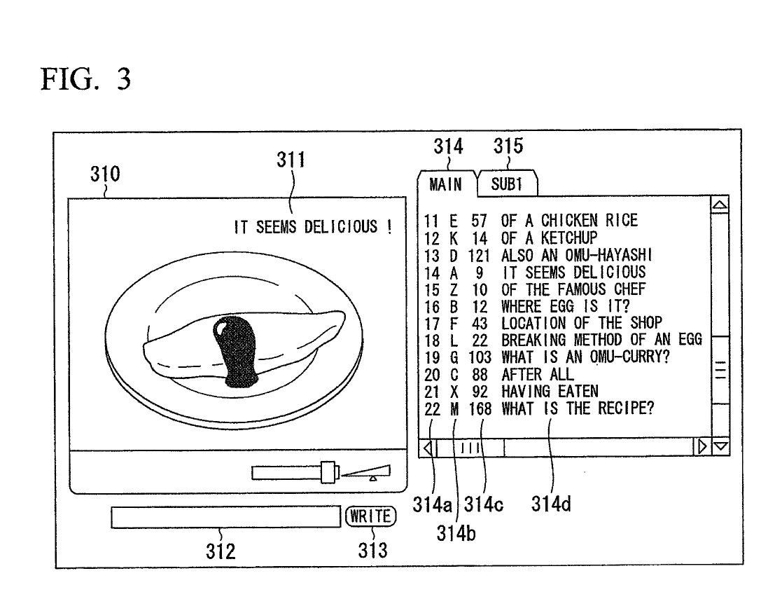

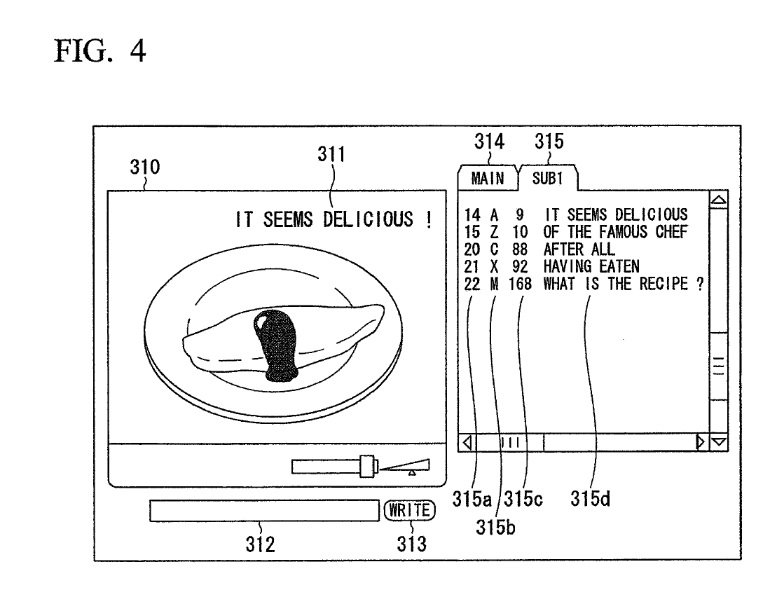

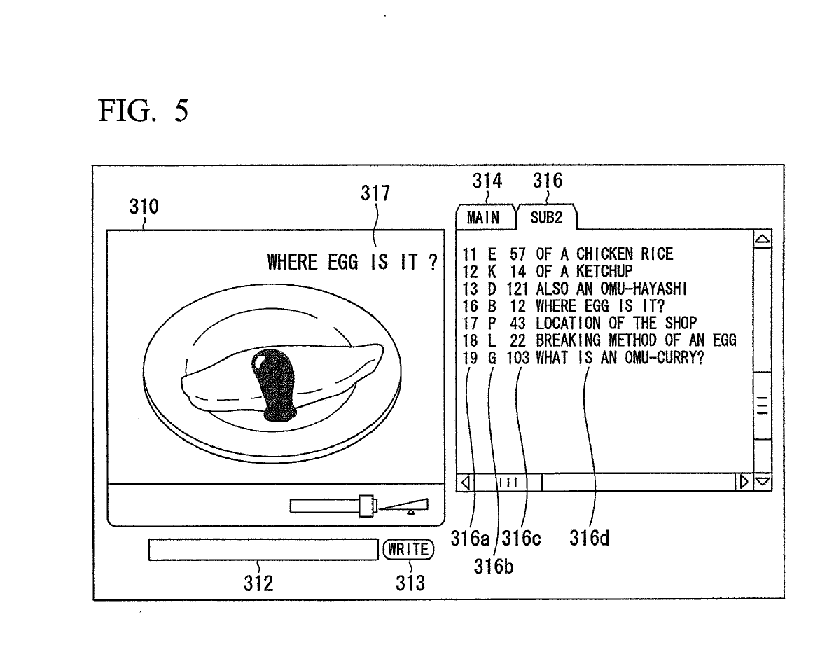

The output unit 306 is an output device which outputs information like the video information which is delivered from the video delivery server 100 or comments which are delivered from the comment server 200. For example, the output unit 306 is a display which outputs the image or a speaker which outputs audio which is included in the video information. FIG. 3, FIG. 4 and FIG. 5 are diagrams showing examples of the player screen which are outputted to the output unit 306. FIG. 3 is a diagram showing an example of the player screen when the main thread is selected among a plurality of threads. At the play region 310 in the player screen, the video delivered from the video delivery server 100 and the comment transmitted from the other user terminal 30 and delivered by the comment server 200 are superimposed and displayed. The comment delivered from the comment server, as shown with reference number 311, is displayed such that the comment scrolls from right to left on the video. Therefore, the user of the comment server 200 is able to share with other users the comment inputted according to the content of the video with watching the video.

The input form 312 is filled with the comment by the user via the input unit 301. If the writing button 313 is clicked, then the text comments filling in the input form 312, the comment-filling time for filling the comments in the input form 312, the video identification information, and user IDs are transmitted to the comment server 200.

The comment list displaying area (main thread) 314, and the comment list displaying area (sub-thread 1) 315 are regions where comments inputted by a plurality of users are listed and displayed for every thread according to the user properties. In this case, the tab corresponding to each thread is displayed, and the thread is changed by clicking the tab. The transmission and reception unit 304 regularly receives the listing comment like this from the comment server 200, and stores the listing comment into the user terminal 300. In the comment list displaying area 314, the number which indicates the comment sequence assigned to the comment (the reference number 314a), the user name who inputs the comment (the reference number 314b), the comment assignment time of writing the comment (the reference number 314c), and a part of the addressed comment (the reference number 314d) are displayed according to the time sequence of the posted real time information.

FIG. 4 is a diagram showing an example of the player screen which selects and displays the sub-thread 1. For example, if a user A, a user Z, a user C, a user X, a user M among a plurality of users are assigned to the same sub-thread 1, the player screen shown in FIG. 4 is displayed in the user terminal 300-1 of the user A.

FIG. 5 is a diagram showing an example of the player screen which selects and displays the sub-thread 2. For example, if a user E, a user K, a user D, a user B, a user P, a user L and a user G among a plurality of users are assigned to the same sub-thread 2, the player screen shown in FIG. 5 is displayed in the user terminal 300-2 of the user B.

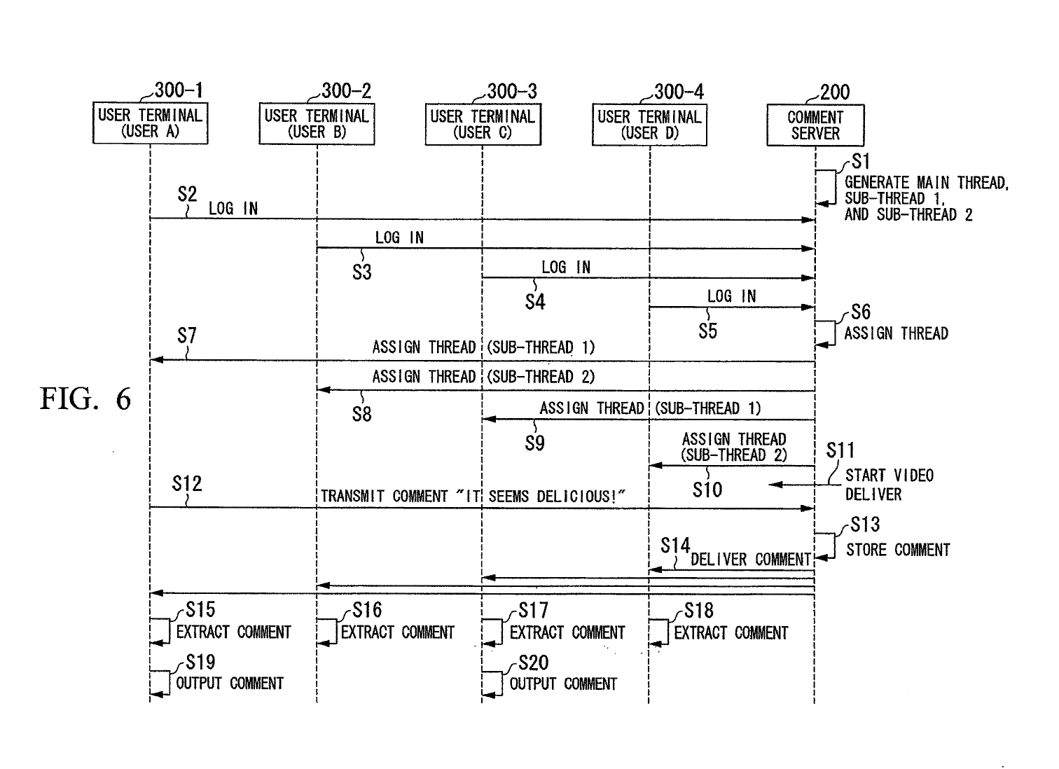

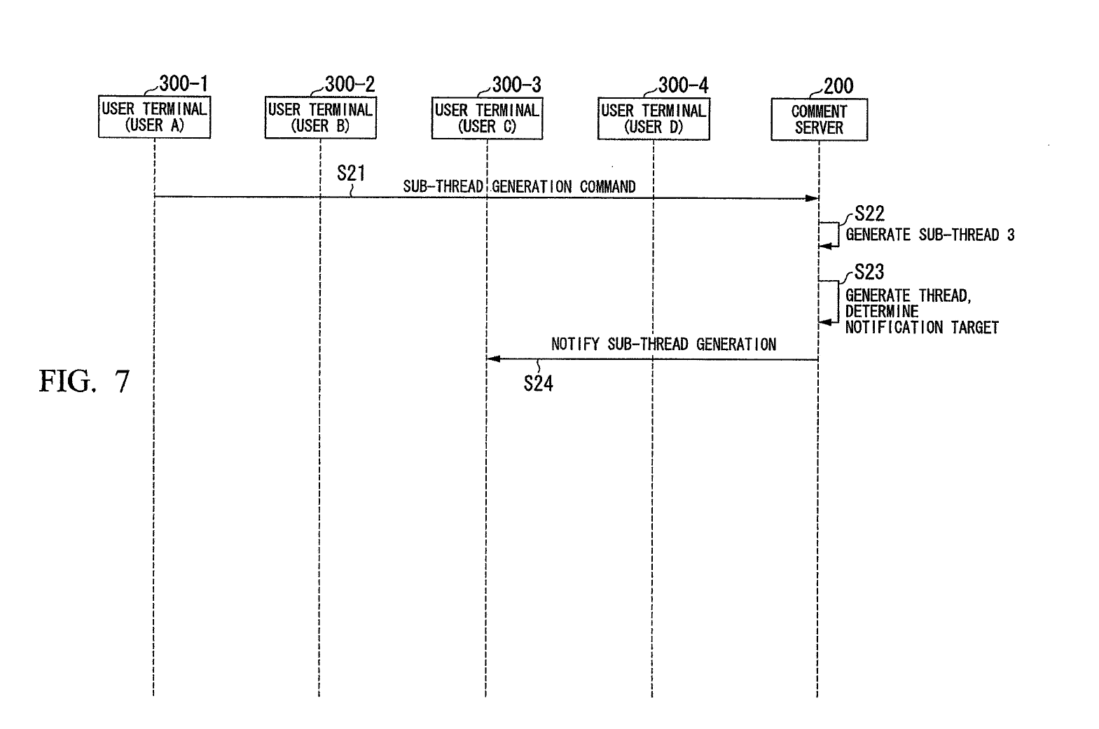

Next, the operation of the information communication system 1 is described with reference to FIG. 6 and FIG. 7.

First, the thread control unit 205 of the comment server 200 generates the thread which matches the video information, and stores the thread into the self memory region. In this case, the main thread which displays the comments of all users, and the sub-thread 1 and the sub-thread 2 which are classified based on the user properties (step S1). If the comment server 200 starts to acquire the reception of the log in request of the user terminal, the user terminal 300-1 of the user A, the user terminal 300-2 of the user B, the user terminal 300-3 of the user C, and the user terminal 300-4 of the user D each perform the log in request to the comment server 200, and log in (steps S2 to S5).

Before the video information begins to be delivered, the comment server 200 assigns the thread according to the user property corresponding to each user terminal which is performed the log in (step S6). In this case, the sub-thread 1 is assigned to the user terminal 300-1, the sub-thread 2 is assigned to the user terminal 300-2, the sub-thread 1 is assigned to the user terminal 300-3, and the sub-thread 2 is assigned to the user terminal 300-4 (steps S7 to S10).

If the video delivery server 100 starts delivering the video (step S11), the comment server 200 starts the reception of the comment. For example, the user terminal 300-1 transmits the comment “It seems delicious!” (step S12), the comment receiving unit 201 of the comment server 200 receives the comment transmitted from the user terminal 300-1, and the comment storage unit 203 stores the comment (step S13). Then, the comment delivery unit 206 of the comment server 200 delivers a comment which is stored in the comment storage unit 203 to each user terminal 300 (step S14). If the user terminal 300 receives the comment which is delivered, the comment extracting unit 305 extracts the comment which is displayed (step S15 to step S18). In this case, the user terminal 300 is the user terminal 300-3 which is assigned the sub-thread (sub-thread 1) which is similar to the user terminal 300-1. Therefore, the user terminal 300-1 and the user terminal 300-3 are only outputted the comment (step S19, step S20).

FIG. 7 is a sequence diagram showing an operation of generating the sub-thread by the comment server according to the request of the user terminal 300. The user terminal 300-1 transmits the sub-thread generation command to the server 200 according to the input of the operation information from the user A (step S21). If the comment server 200 receives the sub-thread generation command transmitted from the user terminal 300-1, the comment server 200 generates the sub-thread 3 (step S22). Then, the thread control unit 205 determines what should be given by itself a notice of the sub-thread via the comment delivery unit 206 (step S23). In this case, the thread control unit 205 determines that the notifying object of generating the sub-thread 3 is the user terminal 300-3 (step S24). The user terminal 300-3 which received the sub-thread generation notification displays a comment which indicates that the sub-thread is generated at the play region 310 of the screen which is displayed on the output unit 306-3 of the user terminal 300-3. In this case, if the comment which notifies generation of the sub-thread is clicked, it may be operated such that the sub-thread is selected.

In the embodiment, the user terminal 300 changes between the main thread which includes all user's comments and the sub-thread which is assigned according to the user property and includes comments from the user terminal 300 which have the same user property, and displays them.

Therefore, the comment server 200 allows users to grasp the flow of comments of all users which are connected to the comment server 200, and is able to transmit and receive the comment between the small scale people by the sub-thread among the user terminals which have the common user property. Therefore, it is possible to achieve multiple communication between both of a large number of people and a small number of people.

In the above-described embodiment, the comment server 200 delivers the video as contents to the user terminals 300. It is possible as a modification that the comment server 200 delivers other contents to the user terminals 300, wherein the other contents may be, for example, audio information that varies over time.

In the embodiment, the corresponding thread is assigned according to the user property of the user terminal 300. However, the assignment of the thread may be assigned according to the time or order that the user terminal performs the log in. In addition, the thread control unit 205 may adjust the thread assignment based on the user number to disperse the number of the user terminals 300 which are assigned to a specific thread. If the user terminal 300 which is assigned a specific thread is over the predetermined threshold, the new other thread is generated, and the user terminal 300 which is assigned to the specific thread is moved to the other thread, and the user number is dispersed.

In the foregoing embodiment, if the main thread and a plurality of sub-threads exist and the main thread is selected, then the comments of all users are displayed. If the sub-thread is selected, then the comment which corresponds to the selected sub-thread from the corresponding user terminal 300 is displayed. It is possible that as a modification that comments belonging to an unselected thread may be displayed semi-transparently. For example, if the sub-thread is selected, the comments of the main thread of all users may be displayed like thin filter is adapted. Therefore, it is possible to know the flowing of the conversation of the main thread. In addition the comment of other threads of the selected thread may be outputted using a constant ratio (for example, 30%).

In addition, if the thread control unit 205 generates the new thread during the delivery of the video information, then the user terminal 300 having the user property corresponding to the generated thread may automatically select and change the generated new thread.

In addition, the information of the user property which is stored in the user information storage unit 204 may be inputted and stored for the service. In addition, the information which is preliminary registered in an SNS (Social Network Service) which is provided via a network may be stored.

In addition, for example, the comment server 200 may deliver a comment which indicates that the specific user gets a present based on the inputted comment information.

In addition, for example, if the user terminal 300 controls the comment according to a baseball game, the anticipation of a victory or a defeat may be acquired before the baseball game starts, the anticipation may be totalized and be notified to all users as the comment. In addition, an extra time period may be given to users immediately after the game is finished. The extra time period is a period of time when users are allowed to give their comments to the comment server 200.

In addition, the property value which may correspond to the comment inputted by the user from the input unit 301 of the user terminal 300 and may be transmitted to the comment server 200, and a property value may be included in the comment information which is stored in the comment storage unit 203. For example, if the video of the baseball game is transmitted, then the input button is displayed to allow a user to click the displayed input button. Clicking the displayed input button by the user allows the comment transmission unit 303 to give property values to the comments and to transmit the comments with the property values to the comment server 200. The property values indicate which team the user prefers and how much the user prefers the term. As a modification, it is possible that based on the inputted property values, the user terminal 300 may be designed to generate threads, assign the threads and decide whether to give the user a special gift.

In addition, the comment which is displayed on the play region of the video information of the output unit 306 of the user terminal 300 may be displayed using different color for every threads. Therefore, which thread the comment belongs is visually understood easily.

In addition, by applying the embodiment, a quiz game which selects “correct” or “incorrect” may be performed. In this case, the asked question is delivered as the video information, the sub-thread which belongs to the property whose answer is “correct” or “incorrect” is generated respectively. The user gives the user terminal the operation information for selecting a sub-thread, thereby allowing the user terminal to select a sub-thread that the users think correct. Then, if the selection of the user terminal 300 is correct, the user terminal 300 remains with the user terminal 300 being assigned to the sub-thread. If the selection of the user terminal 300 is incorrect, the user terminal 300 automatically moves to the main thread by the system, and it is controlled that the user terminal 300 is not able to move the sub-thread.

In addition, in the embodiments, it is also possible to control the processing unit by recording on a computer-readable recording medium a program which realizes the comment control, and by causing this program recorded on a recording medium to be read and executed by a computer system. Note that, here, ‘computer system’ includes the OS and hardware such as peripheral devices and the like. In addition ‘computer system’ includes the WWW system which includes the home page provision environment (or the display environment). Moreover, ‘computer readable recording medium’ refers to a storage medium such as a portable medium such as a flexible disc, a magneto-optical disc, ROM, CD-ROM, hard disc incorporated in a computer system or the like. Furthermore, ‘computer readable recording medium’ also includes devices that hold a program dynamically for short periods of time such as communication lines when the program is transmitted via a network such as the Internet or via a communication circuit such as a telephone line, and includes devices which hold a program for a fixed period of time such as the volatile memory incorporated in computer systems which form the servers and clients in the case of the communication lines or networks described above.

The above described program may be transmitted from the computer system which stores the program in the storage device to other computer system via the communication medium or the transmission wave in the transmission medium. In this case, ‘transmission medium’ which transmits the program is the medium which has the function of transmitting the information like the network (for example, the internee) or the communication line (for example, the telephone line). The above described program, for example differential file (differential program), may realize a portion of the above described functions or may realize the above described functions in combination with a program which has already been recorded on a computer system.

Embodiment of this invention have been described in detail above with reference made to the drawings, however, the specific structure of this invention is not limited to these embodiments and other designs and the like are also included insofar as they do not depart from the spirit or scope of this invention.

What is claimed is:

1. An information communication system comprising a plurality of user terminals which output contents delivered via a network and accept input of comments relating to the contents, and an information communication server which receives the comments input by the user terminals and delivers the comments to a plurality of user terminals,
the information communication server comprising:
a classification control unit which generates a classification according to user properties of a user terminal, and assigns the classification to the user terminal;
the user terminal comprising:
a classification selection input unit which acquires one of a first selection and a second selection, all comments transmitted by a plurality of the user terminal are outputted in the first selection, and the comment transmitted by the user terminal assigned same classification of the user terminal is only outputted in the second selection;
a comment extracting unit which extracts all the comments delivered by the information communication server as an output comment when the first selection is inputted in the classification selection input unit, and extracts the comment transmitted by the user terminal assigned the classification which is the same as the user terminal in the comments delivered by the information communication server when the second selection is inputted in the classification selection input unit; and
an output unit which outputs the output comment extracted by the comment extracting unit with the contents.

2. The information communication system according to claim 1, wherein
the information of the contents to be outputted varies over time; and
the classification control unit of the information communication server generates a new classification according to the change of the contents, and assigns the new classification to the user terminal among a plurality of user terminals based on the new classification.

3. The information communication system according to claim 1, wherein
the user terminal further comprises a classification generation requesting unit which transmits the generation request according to the inputted user property to the information communication server,
the classification control unit of the information communication sever generates a new classification according to the classification generation request transmitted by the classification generation requesting unit of the user terminal, and assigns the new classification to the user terminal among a plurality of user terminals based on the new classification.

4. The information communication system according to claim 2, wherein
the comment extracting unit of the user terminal extracts the comment transmitted by the user terminal assigned the new classification among the comments transmitted to the information communication server as the second selection is inputted when the new classification is assigned by the classification control unit.

5. The information communication system according to claim 2, wherein the classification control unit of the information communication server deletes the generated new classification based on the predetermined condition.

6. An information communication method using a plurality of user terminals which output contents delivered via a network and accept input of comments relating to the contents, and an information communication server which receives the comments input by the user terminals and delivers the comments to a plurality of user terminals, the information communication method comprising:
performing, by the information communication server, a classification controlling process which generates a classification according to user properties of a user terminal, and assigns the classification to the user terminal;
performing, by the user terminal, a classification selection inputting process which acquires one of a first selection and a second selection, all comments transmitted by a plurality of the user terminal are outputted in the first selection, and the comment transmitted by the user terminal assigned same classification of the user terminal is only outputted in the second selection;
performing, by the user terminal, a comment extracting process which extracts all the comments delivered by the information communication server as an output comment when the first selection is inputted in the classification selection inputting process, and extracts the comment transmitted by the user terminal assigned the classification which is same as the user terminal in the comments delivered by the information communication server when the second selection is inputted in the classification selection inputting process; and
performing, by the user terminal, an outputting process which outputs the output comment extracted by the comment extracting step with the contents.
